(19) United States
(12) Patent Application Publication
(10) Pub. No.: US 2018/0220749 A1
(43) Pub. Date: Aug. 9, 2018

(54) TONGUE FOR SEATBELT DEVICE

(71) Applicant: KABUSHIKI KAISHA TOKAI-RIKA-DENKI-SEISAKUSHO, Aichi-ken (JP)

(72) Inventor: Daiki KATO, Aichi-ken (JP)

(21) Appl. No.: 15/887,224

(22) Filed: Feb. 2, 2018

(30) Foreign Application Priority Data
Feb. 8, 2017 (JP) 2017-021549

(51) Int. Cl. A44B 11/25

(52) U.S. Cl. CPC A44B 11/2553; B60R 2022/1812; A44B 11/2561

(57) ABSTRACT

At a present tongue, four suppressing portions are provided between both abutment portions of a tongue main body. In a state in which transverse direction both side portions of a webbing are nipped between a pressing portion of a clamp member and the both abutment portions, a transverse direction central side portion of the webbing is nipped between the pressing portion of the clamp portion and the respective suppressing portions. Due thereto, one of the transverse direction central side portion of the webbing and the transverse direction both side portions of the webbing is pulled by another, and sliding toward the side of the another can be suppressed.

### CROSS-REFERENCE TO RELATED APPLICATION

This application claims priority under 35 USC 119 from Japanese Patent Application No. 2017-021549 filed Feb. 8, 2017, the disclosure of which is incorporated by reference herein.

### BACKGROUND

### Field of the Invention

The present disclosure relates to a tongue for a seatbelt device in which a webbing is held by being nipped between a clamp member and a tongue main body.

### Related Art

International Publication No. WO2015/025801 discloses a locking tongue at which, due to a lock member being moved to a lock position, a webbing is nipped between the lock member and a restricting portion of a tongue main body, and, due thereto, movement of the webbing in the length direction is limited. At the locking tongue disclosed in International Publication No. WO2015/025801, the portion, which abuts the webbing, of the restricting portion of the tongue main body is shorter than the width dimension of the webbing. Therefore, at the locking tongue, the transverse direction intermediate portion of the webbing is nipped between the lock member and the restricting portion of the tongue main body.

Therefore, in a case in which the webbing is pulled in the length direction in a state in which the webbing is nipped between the lock member and the restricting portion of the tongue main body, it is easy for the transverse direction outer side portions of the webbing to move in the length direction as compared with the transverse direction central side portion thereof. Due thereto, the transverse direction central side portion of the webbing is pulled by the transverse direction outer side portions, and there is the possibility that the transverse direction central side portion of the webbing will start to slide toward a transverse direction one side or other side.

### SUMMARY

In view of the above-described circumstances, a tongue for a seatbelt device that can suppress sliding of a webbing toward transverse direction sides is obtained.

A tongue for a seatbelt device of a first aspect has: a tongue main body that has an insertion portion, which is configured to be inserted into a buckle of a seatbelt device, and an insert-through portion through which a webbing is inserted; a clamp member that is provided at the tongue main body so as to be displaceable with respect to the tongue main body; and an opposing portion that is provided at the tongue main body, and that limits movement of the webbing in a length direction of the webbing due to both side portions of the webbing in a transverse direction of the webbing and a central side portion of the webbing in the transverse direction being nipped between the opposing portion and the clamp member by displacement of the clamp member.

In the tongue for a seatbelt device of the first aspect, when the clamp member is displaced, the transverse direction both side portions and the transverse direction central side portion of the webbing are nipped between the clamp member and the opposing portion of the tongue main body. Due thereto, movement of the webbing toward the length direction sides is limited. By limiting the movement of the transverse direction both side portions and the transverse direction central side portion of the webbing toward the length direction sides of the webbing in this way, the webbing being pulled (tensed) toward the transverse direction outer sides and the transverse direction central side can be suppressed, and sliding of the webbing toward the transverse direction sides can be suppressed.

In a tongue for a seatbelt device of a second aspect, in the tongue for a seatbelt device of the first aspect, a catching portion, on which the webbing is caught from a side of the webbing in the transverse direction, is provided at the opposing portion.

In the tongue for a seatbelt device of the second aspect, due to the webbing catching, from a transverse direction side thereof, on the catching portion that is provided at the opposing portion of the tongue main body, movement of the webbing toward the transverse direction sides is limited, and sliding of the webbing toward the transverse direction sides can be suppressed further.

In a tongue for a seatbelt device of a third aspect, in the tongue for a seatbelt device of the second aspect, three or more catching portions are provided.

In the tongue for a seatbelt device of the third aspect, because three or more catching portions are provided, sliding of the webbing toward the transverse direction sides can be suppressed more effectively.

In a tongue for a seatbelt device of a fourth aspect, in the tongue for a seatbelt device of any one of the first through third aspects, the tongue main body has a metal core that has the insertion portion, and a covering portion that is formed of a synthetic resin material and covers the metal core; and the opposing portion is formed by making a portion of the covering portion be thicker than the another portion of the covering portion.

In the tongue for a seatbelt device of the fourth aspect, the opposing portion is formed by making a portion of the covering portion be thick, which is formed of a synthetic resin material. Therefore, so-called a sink mark, which is a dent arising due to molding shrinkage of the synthetic resin material, being generated within the range of formation of the opposing portion at the covering portion can be suppressed.

As described above, the tongue for a seatbelt device relating to the present invention can suppress sliding of a webbing toward transverse direction sides.

### BRIEF DESCRIPTION OF THE DRAWINGS

An exemplary embodiment will be described in detail with reference to the following figures, wherein:

FIG. 1 is an elevation in which a seatbelt device, to which a tongue for a seatbelt device relating to an exemplary embodiment is applied, is seen from a vehicle front side;

FIG. 2 is a perspective view in which an opposing portion of a tongue main body of the tongue for a seatbelt device relating to the exemplary embodiment, a clamp member, and the vicinity thereof are enlarged;

FIG. 3 is a cross-sectional view of the tongue main body along line 3-3 of FIG. 2, showing a state in which a webbing is nipped between a pressing portion of the clamp member and the opposing portion of the tongue main body;

FIG. 4 is a cross-sectional view of the tongue along line 4-4 of FIG. 2, and is a drawing showing a state before an insertion portion of a metal core of the tongue is inserted into a buckle;

FIG. 5 is a cross-sectional view of the tongue along line 4-4 of FIG. 2, and is a drawing showing a state in which the insertion portion of the metal core of the tongue is inserted in the buckle;

FIG. 6 is a cross-sectional view of the tongue along line 4-4 of FIG. 2, and is a drawing showing a state in which the clamp member has been rotated toward a clamp rotation direction side; and

FIG. 7 is a cross-sectional view of the tongue along line 4-4 of FIG. 2, and is a drawing showing a state in which the webbing is nipped between the pressing portion of the clamp member and the opposing portion of the tongue main body.

### DETAILED DESCRIPTION

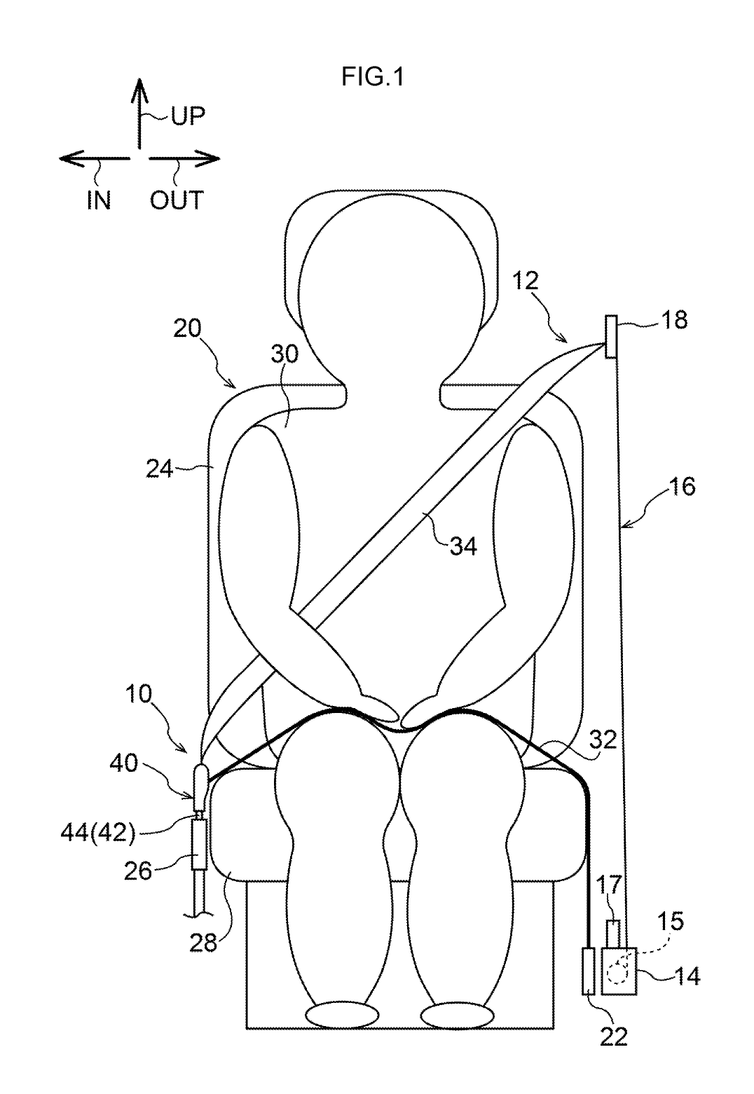

An exemplary embodiment is described next on the basis of the respective drawings of FIG. 1 through FIG. 7. Note that arrow FR in the respective drawings indicates the front side of a vehicle to which a present seatbelt device 12 is applied, arrow OUT indicates the vehicle transverse direction outer side, arrow IN indicates the vehicle transverse direction inner side, and arrow UP indicates the vehicle upper side.

<Structure of Present Exemplary Embodiment>

As shown in FIG. 1, the seatbelt device 12, to which is applied a tongue 10 for a seatbelt device relating to an exemplary embodiment (hereinafter simply called “tongue 10”), has a webbing take-up device 14 serving as a webbing accommodating portion. The webbing take-up device 14 is disposed, for example, at the vehicle lower side of a center pillar of the vehicle, and is fixed to the vehicle body or the like that structures the vehicle. The webbing take-up device 14 has a spool 15. The central axis direction of the spool 15 is the vehicle front and rear direction (the far side and the near side in the drawing of FIG. 1), and the spool 15 can rotate in a take-up direction around the central axis and in a pull-out direction that is opposite thereto. A webbing 16 is provided at the spool 15.

The webbing 16 is shaped as an elongated strip, and the length direction base end portion of the webbing 16 is anchored on the spool 15. The webbing 16 is accommodated in the webbing take-up device 14 in a state of being wound-up on the outer peripheral portion of the spool 15 from the length direction base end side of the webbing 16. Further, the webbing take-up device 14 has a pretensioner 17. The pretensioner 17 is operated at the time of an emergency of the vehicle such as at the time of a vehicle collision or the like, and the spool 15 is rotated in the take-up direction due to the pretensioner 17 being operated. Due thereto, the webbing 16 is taken-up onto the spool 15. Moreover, the webbing take-up device 14 has a locking mechanism (not shown in the drawings). The locking mechanism is operated at the time of an emergency of the vehicle such as at the time of a vehicle collision or the like. Due to the locking mechanism being operated, rotation of the spool 15 in the pull-out direction is limited, and pulling-out of the webbing 16 from the spool 15 is limited.

On the other hand, the portion of the webbing 16 which is further toward the length direction distal end side than the spool 15 extends along the center pillar toward the upper side of the vehicle, and passes-through a slit-hole of a shoulder anchor 18 that is provided in a vicinity of the vehicle upper side end portion of the center pillar, and is folded-back toward the vehicle lower side. The length direction distal end portion of the webbing 16 that has been folded-back toward the vehicle lower side is anchored on an anchor 22. The anchor 22 is disposed at the vehicle transverse direction outer side of a seat 20 of the vehicle, and is fixed to the vehicle body. The tongue 10 relating to the present exemplary embodiment is provided between the length direction distal end of the webbing 16 (the portion anchored on the anchor 22) and the shoulder anchor 18.

A buckle 26 is provided at the vehicle transverse direction inner side of the seat 20 (the side of the seat 20 that is opposite the side at which the webbing take-up device 14 and the anchor 22 are located). The buckle 26 is mounted to the vehicle body or to a member that structures the frame of the seat 20 or the like. The buckle 26 can hold the tongue 10. In a state in which the webbing 16 is placed around the body of a vehicle occupant 30 who is seated on a seat cushion 28 of the seat, the webbing 16 is applied to the body of the vehicle occupant 30 due to the tongue 10 being held by the buckle 26.

In the state in which the webbing 16 is applied to the body of the vehicle occupant 30, the portion, which is between the tongue 10 and the anchor 22, of the webbing 16 is a lap webbing 32. The waist portion of the vehicle occupant 30 is restrained by the lap webbing 32. In contrast, the portion, which is between the shoulder anchor 18 and the tongue 10, of the webbing 16 is a shoulder webbing 34. The shoulder portion, the chest portion and the like of the vehicle occupant 30 are restrained by the shoulder webbing 34.

<Structure of Tongue 10>

The structure of the tongue 10 is described next.

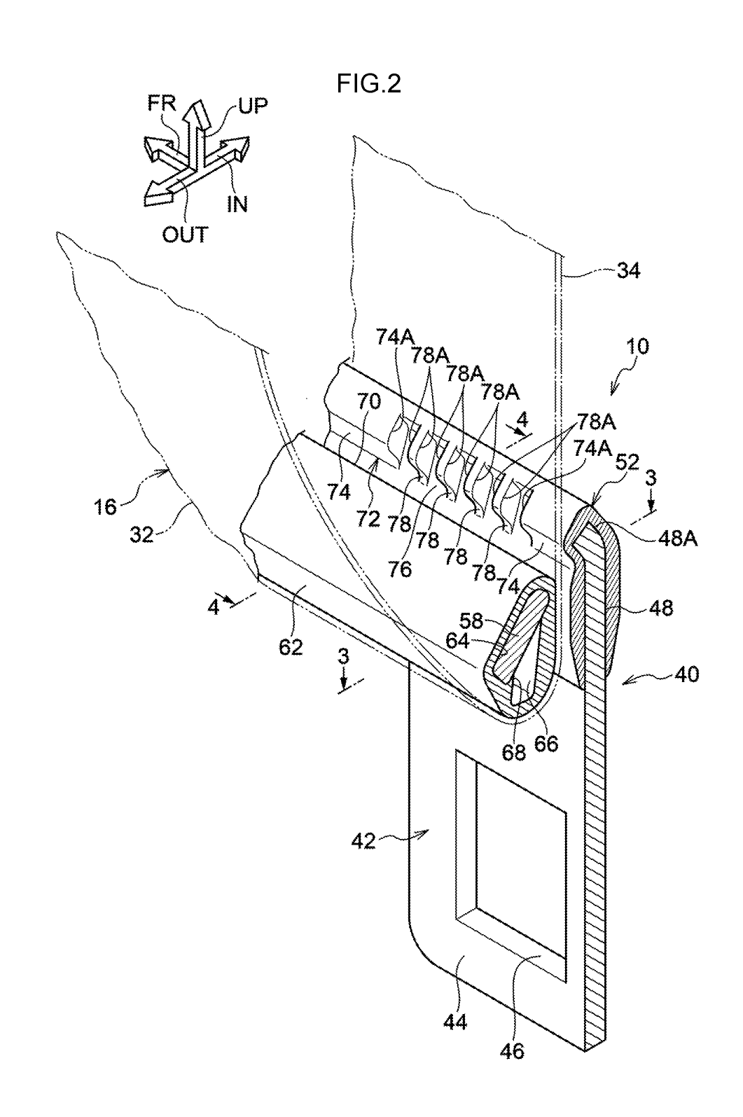

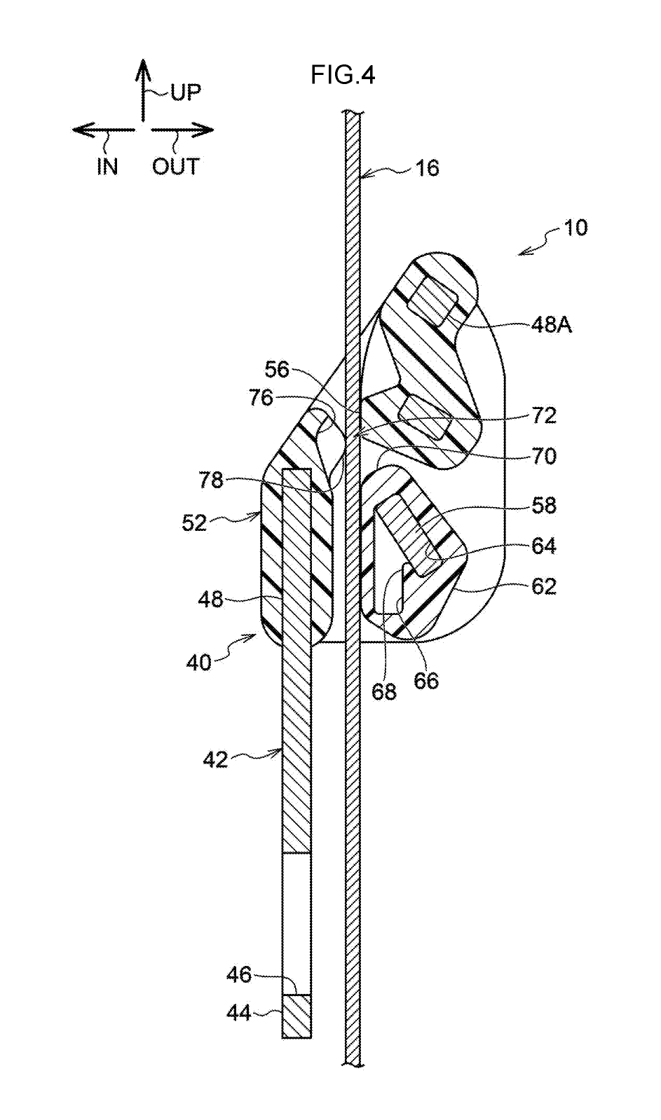

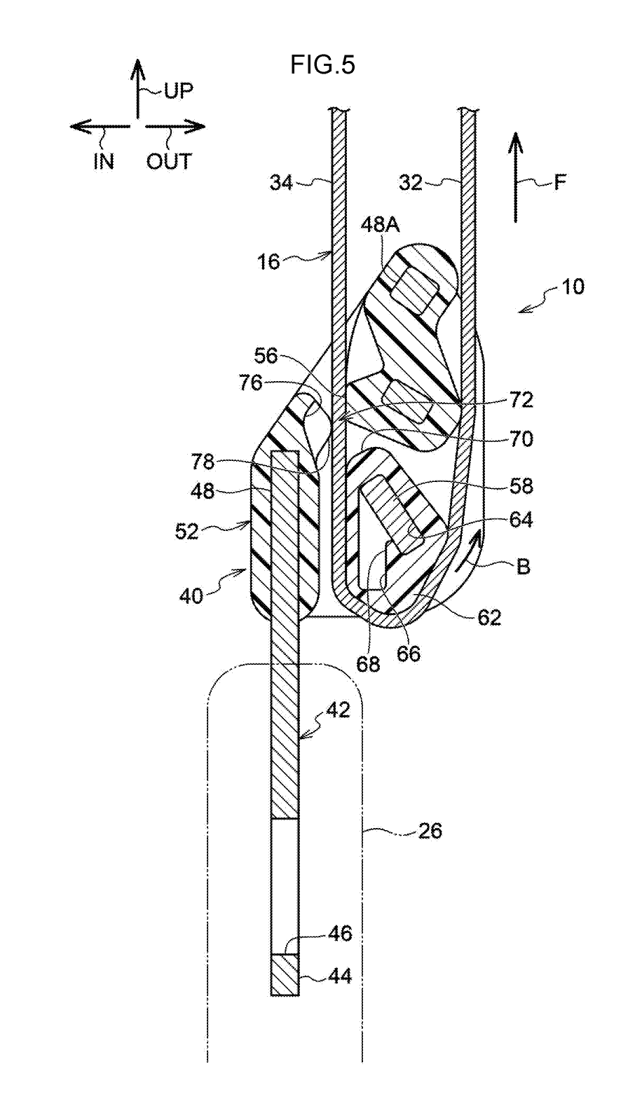

As shown in FIG. 2 and FIG. 4, the tongue 10 has a tongue main body 40. The tongue main body 40 has a metal core 42. The metal core 42 is formed by, for example, punching-out a flat plate of a metal such as iron, stainless steel or the like, and carrying out bending forming. The metal core 42 has an insertion portion 44. At the time when the tongue 10 is held by the buckle 26 (refer to FIG. 1 and FIG. 5), the insertion portion 44 is inserted in the buckle 26 from an opening portion formed in the buckle 26. A though-hole 46 is formed in the insertion portion 44. When the insertion portion 44 is inserted in the buckle 26, a latch provided at the buckle 26 enters into the through-hole 46. Due thereto, movement in the direction of the insertion portion 44 coming-out from the buckle 26 (toward the vehicle upper side in FIG. 5 and the like) is limited, and, due thereto, the tongue 10 is held by the buckle 26.

Further, as shown in FIG. 2 and FIG. 4, the metal core 42 has a base portion 48. The base portion 48 is the portion that is further toward the vehicle upper side than the insertion portion 44 (i.e., is the portion of the metal core 42 that is at the side with respect to the insertion portion 44 which side is opposite the direction of insertion into the buckle 26). A vehicle upper side portion 48A, which is further toward the vehicle upper side than a vehicle vertical direction intermediate portion of the base portion 48, is bent toward the vehicle transverse direction outer side. Further, a covering portion 52 is provided at the base portion 48. The covering portion 52 is formed of a synthetic resin material, and the base portion 48 is covered by the covering portion 52.

Moreover, as shown in FIG. 4, an insert-through hole 56 that serves as an insert-through portion is provided in the covering portion 52. A hole, which passes-through in the thickness direction of the vehicle upper side portion 48A of the base portion 48, is formed in the portion, which corresponds to the insert-through hole 56 of the covering portion 52, at the vehicle upper side portion 48A of the base portion 48 of the metal core 42. The insert-through hole 56 of the covering portion 52 is formed by the inner side portion of this hole of the base portion 48 being covered by the covering portion 52.

The insert-through hole 56 passes-through in the vehicle vertical direction, and the dimension thereof in the vehicle front and rear direction (the far side and the near side of the drawing of FIG. 4, and the arrow FR direction and the direction opposite thereto in FIG. 2) is greater than or equal to the width dimension of the webbing 16. The webbing 16 passes-through the inner side of the insert-through hole 56. Due thereto, the tongue 10 can move in the length direction of the webbing 16 along the webbing 16.

A guide bar 58 serving as a guiding portion is provided at the tongue main body 40. The guide bar 58 is disposed further toward the vehicle lower side than the insert-through hole 56 of the covering portion 52 and further toward the vehicle transverse direction outer side than the insert-through hole 56. The guide bar 58 is formed of a metal such as iron, stainless steel or the like for example. The guide bar 58 is shaped as a flat plate. The shape, when viewing the guide bar 58 in the thickness direction, is rectangular. The length direction of the guide bar 58 is generally the vehicle front and rear direction (the far side and the near side of the drawing of FIG. 4, and the arrow FR direction and the direction opposite thereto in FIG. 2).

Further, the cross-sectional shape when the guide bar 58 is cut in a direction orthogonal to the length direction is rectangular. The transverse direction of the guide bar 58 is inclined in the vehicle vertical direction with respect to the vehicle transverse direction. A transverse direction one side (vehicle transverse direction inner side) end of the guide bar 58 is disposed further toward the vehicle upper side than a transverse direction another side (vehicle transverse direction outer side) end of the guide bar 58. The vehicle front side end portion of the guide bar 58 is held by a front leg plate (not shown in the drawings) that extends toward the vehicle transverse direction outer side from the vehicle front side end portion of the vehicle upper side portion 48A of the base portion 48 of the metal core 42. The vehicle rear side end portion of the guide bar 58 is held by a rear leg plate (not shown in the drawings) that extends toward the vehicle transverse direction outer side from the vehicle rear side end portion of the vehicle upper side portion 48A of the base portion 48 of the metal core 42.

A clamp member 62 is provided at the guide bar 58. The clamp member 62 is formed in the shape of a rod whose length direction runs along the vehicle front and rear direction (the far side and the near side of the drawing of FIG. 4, and the arrow FR direction and the direction opposite thereto in FIG. 2). A supporting hole 64 is provided in the clamp member 62. The supporting hole 64 passes-through the clamp member 62 in the length direction of the clamp member 62. The cross-sectional shape of the supporting hole 64, which is cut in a direction orthogonal to the length direction of the clamp member 62, is substantially rectangular and is slightly larger than the cross-sectional shape of the guide bar 58. As shown in FIG. 4 and FIG. 5, in the initial state of the tongue 10, the guide bar 58 is disposed at the inner side of the supporting hole 64.

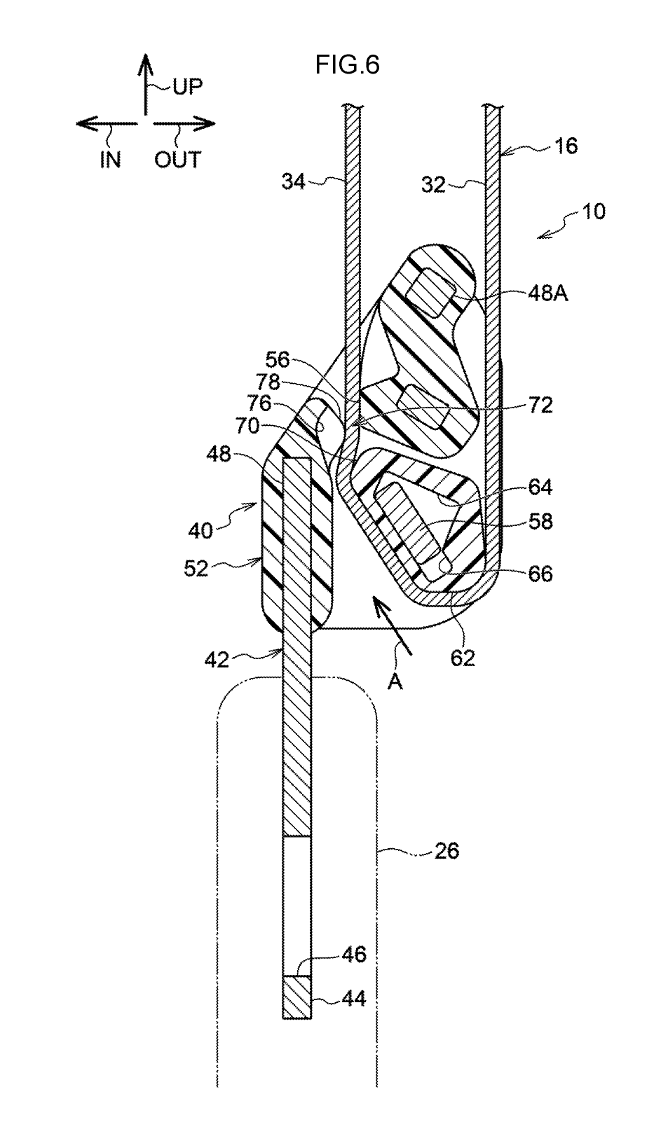

Further, as shown in FIG. 4, a guide hole 66 is formed in the clamp member 62. The cross-sectional shape of the guide hole 66 is substantially rectangular. The thickness dimension of the guide hole 66 is slightly larger than the thickness dimension of the guide bar 58. Further, the width dimension of the guide hole 66 is larger than the width dimension of the guide bar 58. Therefore, as shown in FIG. 6, in the state in which the guide bar 58 is disposed at a transverse direction one side portion of the guide hole 66 at the inner side of the guide hole 66, the clamp member 62 can be displaced toward the transverse direction one side of the guide bar 58 (the arrow A direction side in FIG. 6).

As shown in FIG. 4, the transverse direction of the guide hole 66 is inclined in the vehicle vertical direction with respect to the transverse direction of the supporting hole 64. A transverse direction another side (vehicle transverse direction outer side) end of the guide hole 66 is disposed further toward the vehicle lower side than a transverse direction another side (vehicle transverse direction outer side) end of the supporting hole 64. Further, the transverse direction one side (vehicle transverse direction inner side) end portion of the guide hole 66 is connected to a transverse direction one side (vehicle transverse direction inner side) of the supporting hole 64. As shown in FIG. 5, in the state in which the guide bar 58 is disposed at the inner side of the supporting hole 64, due to the clamp member 62 being rotated in a clamp rotation direction (the arrow B direction in FIG. 5) around the transverse direction one side end portions of the guide hole 66 and the supporting hole 64 such that the transverse direction another side end portion of the guide hole 66 rises toward the vehicle upper side, due thereto, the guide bar 58 is disposed at the inner side of the guide hole 66.

Further, as shown in FIG. 4, the vehicle lower side portion of the supporting hole 64 at the clamp member 62 is a limiting rib 68 that serves as a limiting portion. In the state in which the guide bar 58 is disposed within the supporting hole 64, the limiting rib 68 is provided further toward a transverse direction one side of the clamp member 62 (the vehicle transverse direction inner side) than the transverse direction another side (the vehicle transverse direction outer side) end portion of the guide bar 58, and the limiting rib 68 abuts the vehicle lower side surface of the guide bar 58.

Due thereto, rotation of the clamp member 62 in the clamp rotation direction is limited. The clamp member 62 can rotate in the clamp rotation direction (the arrow B direction in FIG. 5) due to a rotation load, which is of a magnitude exceeding the mechanical strength of the limiting rib 68 (e.g., the shearing strength of the limiting rib 68), being applied to the clamp member 62 and the limiting rib 68 being broken thereby.

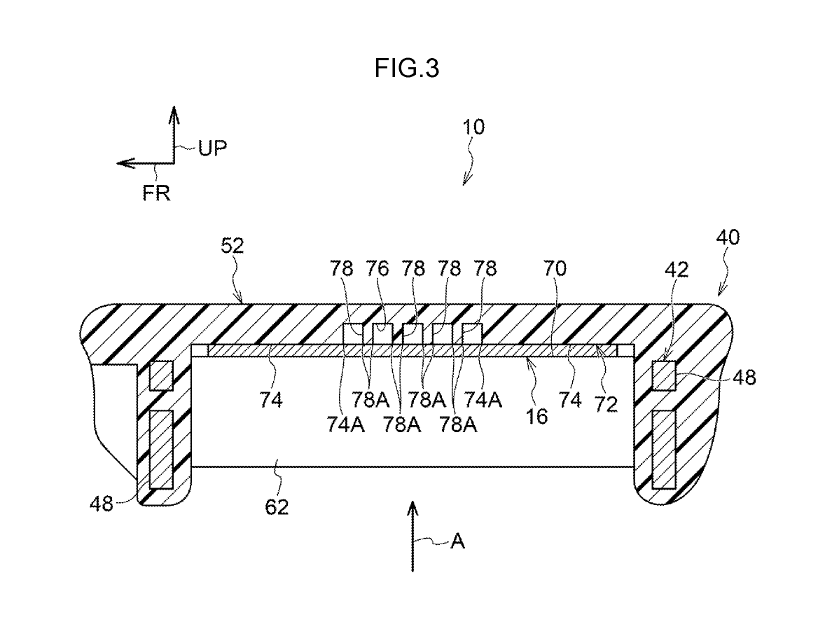

On the other hand, the clamp member 62 has a pressing portion 70. The pressing portion 70 is, of the outer peripheral portion of the clamp member 62, the portion at the vehicle upper side of the vehicle transverse direction inner side portion. Further, an opposing portion 72 is provided at the covering portion 52 of the tongue main body 40. The opposing portion 72 is the portion that opposes the pressing portion 70 in the transverse direction of the guide bar 58, in the state in which the guide bar 58 is disposed within the guide hole 66. The opposing portion 72 is provided at the vehicle lower side of the insert-through hole 56 that is provided in the covering portion 52. As shown in FIG. 3, the opposing portion 72 has a pair of abutment portions 74 that serve as projecting portions (or transverse direction outer side projecting portions).

The one abutment portion 74 is the portion at the vehicle front side (the arrow FR direction side in FIG. 3) of the opposing portion 72. The another abutment portion 74 is the portion at the vehicle rear side (the side opposite the arrow FR direction in FIG. 3) of the opposing portion 72. The abutment portions 74 face the transverse direction both side portions of the portion, which is further toward the vehicle lower side than the insert-through hole 56, of the webbing 16.

In the state in which the guide bar 58 is disposed within the guide hole 66, the clamp member 62 is guided by the guide bar 58 and displaced toward the transverse direction one side of the guide bar 58 (the vehicle transverse direction inner side). Due thereto, the pressing portion 70 of the clamp member 62 is made to abut a thickness direction one side surface of the webbing 16. When the webbing 16 is pressed by the pressing portion 70 of the clamp member 62, the portions of a thickness direction other side surface that are at the transverse direction both side portions of the webbing 16 are made to abut the both abutment portions 74, and the transverse direction both side portions of the webbing 16 are nipped and held between the pressing portion 70 of the clamp member 62 and the both abutment portions 74.

The portion, which is between the both abutment portions 74, at the opposing portion 72 is a concave portion 76. The concave portion 76 does not face the base portion 48 of the metal core 42 in the thickness direction of the covering portion 52 at the portion at which the concave portion 76 is formed at the covering portion 52. Further, the concave portion 76 is formed by making the covering portion 52 of the tongue main body 40 thin. In the state in which the transverse direction both side portions of the webbing 16 are pressed by the pressing portion 70 of the clamp member 62 and are made to abut the both abutment portions 74, the inner side surface of the concave portion 76 is apart from the webbing 16. Four suppressing portions 78 that serve as projecting portions (or transverse direction central side projecting portions) are provided at the inner side of this concave portion 76.

These suppressing portions 78 stand erect from the inner side surface of the concave portion 76. The suppressing portions 78 are plate-shaped, and the thickness direction of the suppressing portions 78 runs along the direction in which the one abutment portion 74 and the another abutment portion 74 face one another (the arrow FR direction and the direction opposite thereto in FIG. 3). These suppressing portions 78 are disposed at a predetermined interval in the direction in which the one abutment portion 74 and the another abutment portion 74 face one another. The suppressing portion 78 that is at the one abutment portion 74 side is disposed so as to be apart from the one abutment portion 74. The suppressing portion 78 that is at the another abutment portion 74 side is disposed so as to be apart from the another abutment portion 74.

The vehicle transverse direction outer side portions of these suppressing portions 78 are made to be substantially the same shapes as the vehicle transverse direction outer side portions of the abutment portions 74. When the webbing 16 is pressed by the pressing portion 70 of the clamp member 62, the portions, which face the suppressing portions 78, of the transverse direction central side portion of the webbing 16 are made to abut the suppressing portions 78, and the transverse direction both side portions of the webbing 16 are nipped and held between the pressing portion 70 of the clamp member 62 and the abutment portions 74.

The vehicle front and rear direction both ends at the vehicle transverse direction outer side portions of the suppressing portions 78 are corner portions 78A that serve as catching portions. Further, the vehicle front and rear direction both ends, at the vehicle transverse direction outer side portions and at the vehicle transverse direction suppressing portion 78 side portions, of the respective abutment portions 74 are corner portions 74A. These corner portions 74A and 78A are not rounded, or are only slightly rounded. Therefore, if, in the state in which the webbing 16 is made to abut the vehicle transverse direction outer side portions of the suppressing portions 78, the webbing 16 starts to move in the vehicle front and rear direction (i.e., in the webbing 16 transverse direction) with respect to the suppressing portions 78, the webbing 16 catches on (engages with) the corner portions 74A of the abutment portions 74 and the corner portions 78A of the suppressing portions 78.

<Operation and Effects of Present Exemplary Embodiment>

At the seatbelt device 12 to which the present tongue 10 is applied, at the time when the vehicle occupant 30 applies the webbing 16, the tongue 10 is grasped, and the webbing 16 is pulled (tensed) together with the tongue 10. Due thereto, the webbing 16 is pulled-out from the spool 15 of the webbing take-up device 14. The webbing 16 which is pulled-out in this way is placed around the body of the vehicle occupant 30 from the front side of the body of the vehicle occupant 30. In this state, the insertion portion 44 of the tongue 10 is inserted in the buckle 26, and the insertion portion 44 is held at the buckle 26. Due thereto, of the webbing 16, the lap webbing 32 is placed around the waist portion of the vehicle occupant 30, and the shoulder webbing 34 is placed around in a range from the shoulder portion via the chest portion to the waist portion of the vehicle occupant 30. In this way, the webbing 16 is applied to the body of the vehicle occupant 30.

By the way, in the state in which the webbing 16 is pulled together with the tongue 10 and the tongue 10 is moved toward a vicinity of the buckle 26, the webbing 16 is placed around the clamp member 62, and is folded-back at the clamp member 62 (see FIG. 5). Therefore, when the webbing 16 is pulled together with the tongue 10 in this state, the clamp member 62 tries to rotate in the clamp rotation direction (the arrow B direction in FIG. 5) due to the resistance between the clamp member 62 and the webbing 16.

Here, in the initial state of the tongue 10, the guide bar 48 abuts the limiting rib 68. Therefore, rotation of the clamp member 62 in the clamp rotation direction is limited by the limiting rib 68. Due thereto, even if the vehicle occupant 30 pulls the webbing 16 together with the tongue 10 at the time when the vehicle occupant 30 applies the webbing 16, the clamp member 62 is not rotated in the clamp rotation direction.

On the other hand, at the time of an emergency of the vehicle such as at the time of a vehicle collision or the like, the pretensioner 17 is operated. Due thereto, the webbing 16 is taken-up onto the spool from the base end side of the webbing 16. Due thereto, the body of the vehicle occupant 30 is strongly restrained by the webbing 16. Moreover, after the pretensioner 17 operates, when the body of the vehicle occupant 30 starts to inertially move toward the vehicle front side, the lap webbing 32 is pulled in the arrow F direction in FIG. 5 by the body of the vehicle occupant 30. Due thereto, the clamp member 62 starts to rotate in the clamp rotation direction (the arrow B direction in FIG. 5) due to the resistance between the clamp member 62 and the webbing 16.

If the rotation load, which is applied to the limiting rib 68 from the clamp member 62 that starts to rotate in the clamp rotation direction, exceeds the mechanical strength of the limiting rib 68 (e.g., the shearing strength of the limiting rib 68), the limiting rib 68 is broken by the clamp member 62, and the clamp member 62 is rotated in the clamp rotation direction. Due thereto, as shown in FIG. 6, the position at which the guide bar 58 is disposed at the clamp member 62 is changed from the inner side of the supporting hole 64 at the clamp member 62 to the inner side of the guide hole 66.

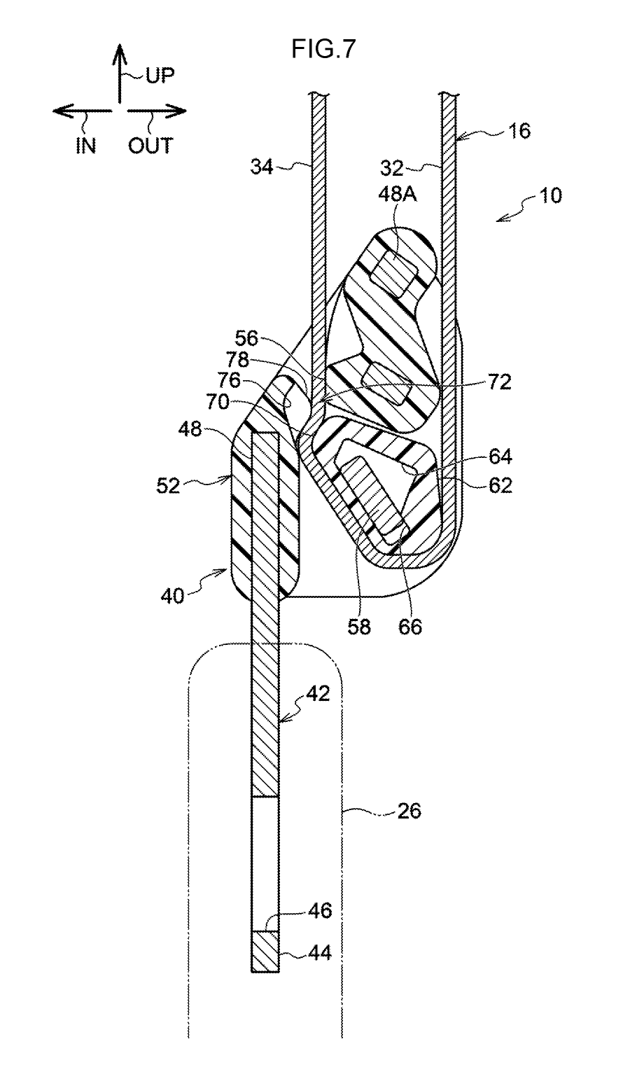

In this state, when the clamp member 62 is further pulled by the webbing 16, the clamp member 62 is guided by the guide bar 58, and is displaced toward the transverse direction one side of the guide bar 58 (the vehicle transverse direction inner side, the arrow A direction in FIG. 6). Due thereto, the pressing portion 70 of the clamp member 62 approaches the opposing portion 72 of the covering portion 52 of the tongue main body 40. As shown in FIG. 7, the pressing portion 70 of the clamp member 62, that has been displaced in this way, is made to abut a thickness direction one side surface of the webbing 16, and the webbing 16 is pressed by the pressing portion 70 of the clamp member 62.

Moreover, the webbing 16 that is pressed by the clamp member 62 is displaced toward the transverse direction one side of the guide bar 58 (the vehicle transverse direction inner side) together with the clamp member 62. Due thereto, a thickness direction another side surface of the webbing 16 is made to abut the both abutment portions 74 and the respective suppressing portions 78 of the opposing portion 72. Due thereto, the webbing 16 is nipped and held between the pressing portion 70 of the clamp member 62, and the both abutment portions 74 and the respective suppressing portions 78 of the tongue main body 40. Due to the webbing 16 being held in this way, at the webbing 16, the shoulder webbing 34 side portion moving toward the lap webbing 32 side can be limited, and the waist portion of the vehicle occupant 30 can be restrained more effectively by the lap webbing 32.

On the other hand, in the present exemplary embodiment, the four suppressing portions 78 are provided at the concave portion 76, between the both abutment portions 74 of the tongue main body 40. Therefore, in the state in which the transverse direction outer side portions of the webbing 16 are nipped between the pressing portion 70 of the clamp member 62 and the both abutment portions 74 of the tongue main body 40, the transverse direction central side portion of the webbing 16 is nipped between the pressing portion 70 of the clamp member 62 and the respective suppressing portions 78 of the tongue main body 40. Due thereto, in the state in which the webbing 16 is nipped between the pressing portion 70 of the clamp member 62 and the both abutment portions 74 of the tongue main body 40, and movement of the webbing 16 toward the length direction sides at the transverse direction both side (outer side) portions of the webbing 16 is limited, movement of the webbing 16 toward the length direction sides at the transverse direction central side portion of the webbing 16 is limited.

Due thereto, in a case in which the webbing 16 is pulled toward a length direction side in such a state in which movement of the webbing 16 toward the length direction sides is limited in this way, one of the transverse direction central side portion of the webbing 16, and the transverse direction both side (outer side) portions of the webbing 16, sliding toward the side of the other can be suppressed. Due thereto, sliding of the webbing 16 toward the transverse direction sides can be suppressed, and the occurrence of folding or the like of the webbing 16 that is due to the webbing 16 sliding toward a transverse direction side can be suppressed.

Further, the respective corner portions 74A of the respective abutment portions 74 and the respective corner portions 78A of the respective suppressing portions 78 of the opposing portion 72 of the covering portion 52 (the tongue main body 40) are not rounded or are only slightly rounded. Therefore, when, in the state in which the webbing 16 abuts the vehicle transverse direction outer side portions of the suppressing portions 78, the webbing 16 starts to move toward a transverse direction side of the webbing 16 with respect to the opposing portion 72 of the covering portion 52 (the tongue main body 40), the webbing 16 catches on (engages with) the respective corner portions 74A of the respective abutment portions 74 and the respective corner portions 78A of the respective suppressing portions 78. Due thereto, movement of the webbing 16 toward the transverse direction sides is limited, and therefore, sliding of the webbing 16 toward the transverse direction sides can be suppressed further.

Moreover, in the present exemplary embodiment, the two corner portions 74A and the eight corner portions 78A (i.e., a total of 10 corner portions) are provided at the opposing portion 72 of the covering portion 52 (the tongue main body 40). Therefore, at the portion, which faces the opposing portion 72, of the webbing 16, the webbing 16 is engaged with the two corner portions 74A and the eight corner portions 78A. Due thereto, movement of the webbing 16 toward the transverse direction sides is effectively limited, and therefore, sliding of the webbing 16 toward the transverse direction sides can be suppressed further.

On the other hand, the opposing portion 72 is formed at the covering portion 52, and the covering portion 52 is formed of a synthetic resin material. By the way, the base portion 48 of the metal core 42 is not disposed at the opposing portion 72 of the covering portion 52. Therefore, at the portions, where the both abutment portions 74 and the respective suppressing portions 78 are formed at the opposing portion 72, the synthetic resin material that forms the covering portion 52 is made to be thick. Here, in the present exemplary embodiment, the concave portion 76 is formed between the both abutment portions 74 of the opposing portion 72, and the four suppressing portions 78 are provided at intervals at the inner side of this concave portion 76. Therefore, at the opposing portion 72, at the regions that are between the abutment portions 74 and the suppressing portions 78 that are adjacent to one another, and at the regions that are between the suppressing portions 78 that are adjacent to one another, the synthetic resin material that forms the covering portion 52 is thin. Due thereto, so-called sink marks, which are dents that arise due to molding shrinkage of the synthetic resin material, being generated at the design surface (the vehicle transverse direction inner side surface) of the portion where the opposing portion 72 is formed at the covering portion 52 can be suppressed.

Note that, in the present exemplary embodiment, there are a total of ten of the respective corner portions 74A of the respective abutment portions 74 and the respective corner portions 78A of the respective suppressing portions 78 of the opposing portion 72 of the covering portion 52 (the tongue main body 40). However, it suffices for the number of catching portions to be three or more.

Further, in the present exemplary embodiment, the suppressing portion is the suppressing portions 78 that are plate-shaped. However, the suppressing portion may be shaped as a projection that is, for example, solid cylindrical or conical or the like, and the shape of the suppressing portion is not limited to a plate shape.

Moreover, in the present exemplary embodiment, there is a structure in which, due to the clamp member 62 being displaced rectilinearly toward a transverse direction one side of the guide bar 58, the webbing 16 is nipped between the clamp member 62, and the abutment portions 74 and the suppressing portions 78 of the tongue main body 40, and the webbing 16 is held. However, the displacement of the clamp member 62 at the time when the webbing 16 is held may be rotation-movement for example, and the displacement of the clamp member 62 at the time when the webbing 16 is held is not limited to rectilinear displacement.

What is claimed is:

1. A tongue for a seatbelt device, comprising:
a tongue main body that has an insertion portion, which is configured to be inserted into a buckle of a seatbelt device, and an insert-through portion through which a webbing is inserted;
a clamp member that is provided at the tongue main body so as to be displaceable with respect to the tongue main body; and
an opposing portion that is provided at the tongue main body, and that limits movement of the webbing in a length direction of the webbing due to both side portions of the webbing in a transverse direction of the webbing and a central side portion of the webbing in the transverse direction being nipped between the opposing portion and the clamp member by displacement of the clamp member.

2. The tongue for a seatbelt device of claim 1, wherein a catching portion, on which the webbing is caught from a side of the webbing in the transverse direction, is provided at the opposing portion.

3. The tongue for a seatbelt device of claim 2, wherein three or more catching portions are provided.

4. The tongue for a seatbelt device of claim 1, wherein:
the tongue main body has a metal core that has the insertion portion, and a covering portion that is formed of a synthetic resin material and covers the metal core; and
the opposing portion is formed by making a portion of the covering portion be thicker than the another portion of the covering portion.

5. The tongue for a seatbelt device of claim 2, wherein:
the tongue main body has a metal core that has the insertion portion, and a covering portion that is formed of a synthetic resin material and covers the metal core; and
the opposing portion is formed by making a portion of the covering portion be thicker than the another portion of the covering portion.

6. The tongue for a seatbelt device of claim 3, wherein:
the tongue main body has a metal core that has the insertion portion, and a covering portion that is formed of a synthetic resin material and covers the metal core; and
the opposing portion is formed by making a portion of the covering portion be thicker than the another portion of the covering portion.
